(19) United States
(12) Patent Application Publication
(10) Pub. No.: US 2011/0284749 A1
(43) Pub. Date: Nov. 24, 2011

(54) Radiation detector

(75) Inventor: Yoshihiro Okada, Kanagawa (JP)

(73) Assignee: FUJIFILM Corporation, Tokyo (JP)

(21) Appl. No.: 13/067,208

(22) Filed: May 17, 2011

(30) Foreign Application Priority Data
May 18, 2010 (JP) 2010-114794

(51) Int. Cl. G01T 1/20; G01T 1/00

(52) U.S. Cl. 250/361 R; 250/336.1

(57) ABSTRACT

The present invention provides a radiation detector that may suppress a decrease in dynamic range, and may improve an S/N ratio at a low radiation amount. Namely, pixels are provided with sensor sections each having different sensitivity characteristics, the sensor sections generating electric charge in response to irradiation of radiation and accumulating the electric charge in accordance with the amount of irradiated radiation. A control signal flows through a switch element provided for each pixel via scan lines. An electric signal corresponding with the electric charge accumulated in the sensor section of each pixel flows through signal lines in accordance with the switching state of the respective switch elements.

### CROSS-REFERENCE TO RELATED APPLICATION

This application claims priority under 35 USC 119 from Japanese Patent Application No. 2010-114794, filed on May 18, 2010 the disclosure of which is incorporated by reference herein.

### BACKGROUND OF THE INVENTION

1. Field of the Invention

The present invention relates to a radiation detector. The present invention particularly relates to a radiation detector with plural pixels arrayed in a matrix, in which charges generated by irradiation with radiation are accumulated, and the amount of accumulated charges are detected as image information.

2. Description of the Related Art

Radiographic imaging apparatuses are recently being implemented that employ radiation detectors having a X-ray sensitive layer disposed on a TFT (thin film transistor) active matrix substrate, and directly converting X-rays information into digital information, such as, for example, a FPD (flat panel detector) radiation detector. Such radiation detectors have the advantage that, in comparison to related imaging plates, images can be more immediately checked and video images can also be checked. The introduction of such radiation detectors is proceeding rapidly.

Various types are proposed for such radiation detectors. There are, for example, direct-conversion-type radiation detectors that convert radiation directly to charges in a semiconductor layer, and accumulate the charges. There are also indirect-conversion-type radiation detectors that first convert radiation into light with a scintillator, such as CsI:Tl, GOS (Gd₂O₂S:Tb) or the like, then convert the converted light into charges and accumulate the charges. Radiation detectors output an electrical signal according to the charge accumulated in each photo diode. In a radiographic imaging apparatus, the electrical signal output from the radiation detector is converted into digital information in an analogue/digital (A/D) converter after the signal has been amplified by an amplifier.

Namely, in the radiation detector, simultaneously realizing an improvement in S/N ratio and a dynamic range may be an important matter.

The photodiode linearly accumulates charges according to the quantity of illuminated light. Accordingly, for improving the S/N ratio in a low radiation amount range, it is effective to improve a sensitivity of the photodiode to light, and to reduce a gain of the amplifier.

However, as shown in FIG. 28, the amplifier has a fixed amplifiable range in electric signals. Therefore, when improving the sensitivity of the photodiode by increasing the amount of generated charges, electric signals may not fall within the amplifiable range of the amplifier, and may result in a lowered dynamic range. Further, when improving the sensitivity of the photodiode, images with a high S/N ratio may be obtained in a low radiation amount range which is important for a radiographic image diagnoses. However, information in a high radiation amount range may not be obtained, and macroscopic images (for example, outline information of a human body) may not be obtained.

Japanese Patent Application Laid-Open No. 2008-270765 discloses a technique that may simultaneously improve the S/N ratio and the dynamic range. This in technique, a current-voltage conversion circuit is disposed in a pixel of a complementary metal oxide semiconductor image sensor (CMOS), information in a diagnosis-target range is amplified at high S/N ratio (small gain), information in a large radiation amount range is converted into voltage at low S/N (large gain), and is output.

The Radiation detector used in a medical field requires a sensor area large enough to accommodate a site of a photo subject, which is a human body. Specifically, general standard size of the sensor area is 35 cm×43 cm, or 43 cm×43 cm. Therefore, it is difficult to manufacture the radiation detector by CMOS which is formed on a silicon substrate with a diameter between 6 inches and 12 inches. Accordingly, the radiation detector is configured by a transistor array which is formed on an insulating substrate such as glass by TFT technology.

However, it is distant to incorporate a current-voltage conversion circuit in the TFT, based on the below reasons.

(1) Current-voltage conversion with high accuracy is difficult, due to uniformity of a threshold value of TFT, manufacturing stability, and low reliability.

(2) An area over 100 times of the CMOS is needed for the current-voltage conversion, due to large minimum wiring width (CMOS≦0.1 μm, TFT nearly equal 5 μm) because of the specification of manufacturing apparatuses.

Accordingly, although the technique for providing the current-voltage conversion circuit within the pixel in the radiation detector has been proposed, putting the technique into practice is difficult.

### SUMMARY OF THE INVENTION

The present invention provides a radiation detector that may suppress a decrease in dynamic range, and may improve an S/N ratio at a low radiation amount, without providing any current-voltage conversion circuit into the pixels.

A first aspect of the present invention is a radiation detector including: a plurality of pixels arranged two dimensionally in a detection region that detects radiation, each of the plurality of pixels including a plurality of sensor sections that generate electric charges in response to irradiation of radiation and accumulates electric charge in accordance with an amount of irradiated radiation, and a switch element for reading the electric charge, and respective sensor sections having different sensitivity characteristics; a plurality of scan lines through each of which a control signal that switches respective switch elements flows; and a plurality of signal lines, through each of which an electric signal corresponding to the electric charge accumulated in the respective sensor sections of each of the pixels flows, in accordance with a switching state of each of the respective switch elements.

Note that, the sensitivity characteristics is the characteristics that shows a relation between the amount of irradiated radiation, such as X-rays or visible light, and the amount of charges accumulated in the sensor section. Further, the sensitivity characteristics are determined by the sizes of the sensor sections, material of the sensor sections, bias voltages applied to the sensor sections, and the like. Here, the size means the largeness of the area of the sensor sections, film thickness thereof, or the both.

Accordingly, the first aspect of the present invention includes plural sensor sections that each has different sensitivity characteristics. Therefore, the first aspect of the present invention may vary the output characteristics of the electric signals that are output from each of the pixel, without providing any current-voltage conversion circuit to the pixels. Accordingly, the first aspect of the present invention may suppress a decrease in dynamic range, and may improve an S/N ratio at a low radiation amount.

A second aspect of the present invention, in the above aspect, each of the sensor sections may have a different saturation value for an amount of electric charge that is accumulated in accordance with the amount of irradiated radiation.

A third aspect of the present invention, in the above aspect, each of the sensor sections may be formed in the same layer and has a different size.

A fourth aspect of the present invention, in the above aspect, may further include an illumination section that is formed on the detection region and that generates light in response to the irradiated radiation, wherein the sensor sections generate charges in response to illumination of light generated by the illumination section, and at least a portion of the sensor sections is shielded from light.

A fifth aspect of the present invention, in the above aspect, may further include a plurality of bias lines, each of which supplies a different bias voltage, wherein an amount of electric charge that may be accumulated by each of the sensor sections may vary in accordance with an applied bias voltage, and wherein each of the sensor sections may be applied with a different bias voltage via a different one of the plurality of bias lines.

A sixth aspect of the present invention, in the above aspect, an auxiliary capacitor that accumulates generated charges may be provided electrically in parallel with each of the sensor sections, at least at one end of each of the sensor sections.

According to the above aspects, the present invention may suppress a decrease in a dynamic range, and may improve an SN ratio at a low radiation amount, without providing any current-voltage conversion circuit into the pixels.

### BRIEF DESCRIPTION OF THE DRAWINGS

Exemplary embodiments of the present invention will be described in detail based on the following figures, wherein:

FIG. 1 is a schematic diagram of the radiographic imaging apparatus according to a first exemplary embodiment;

FIG. 2 is a plan view showing the configuration of the radiation detector according to the first exemplary embodiment;

FIG. 3 is a cross-sectional view of the radiation detector taken along the line A-A of FIG. 2 according to the first exemplary embodiment;

FIG. 4 is a cross-sectional view of the radiation detector taken along the line B-B of FIG. 2 according to the first exemplary embodiment;

FIG. 5 is a cross-sectional view of the radiation detector taken along the line C-C of FIG. 2 according to the first exemplary embodiment;

FIG. 6 is a schematic diagram of the radiation detector of the radiographic imaging apparatus according to the first exemplary embodiment;

FIG. 7 is an equivalent circuit diagram of one pixel of the radiation detector according to the first exemplary embodiment;

FIG. 8A and FIG. 8B are graphs that show the sensitivity characteristic of the sensor sections 103A and 103B according to the first exemplary embodiment;

FIG. 9 is a graph that shows the sensitivity characteristic of the pixel according to the first exemplary embodiment;

FIG. 10 is a plan view showing the configuration of the radiation detector according to a second exemplary embodiment;

FIG. 11 is an equivalent circuit diagram of one pixel of the radiation detector according to the second exemplary embodiment;

FIG. 12A and FIG. 12B are graphs that show the sensitivity characteristic of the sensor section 103A according to the second exemplary embodiment;

FIG. 13A and FIG. 13B are graphs that show the sensitivity characteristic of the sensor section 103B according to the second exemplary embodiment;

FIG. 14 is a graph that shows the sensitivity characteristic of the pixel according to the second exemplary embodiment;

FIG. 15 is a schematic diagram of the radiographic imaging apparatus according to a third exemplary embodiment;

FIG. 16 is a plan view showing the configuration of the radiation detector according to the third exemplary embodiment;

FIG. 17 is a cross-sectional view of the radiation detector taken along the line A-A of FIG. 16 according to the third exemplary embodiment;

FIG. 18 is an equivalent circuit diagram of one pixel of the radiation detector according to the third exemplary embodiment;

FIG. 19A and FIG. 19B are graphs that show the sensitivity characteristic of the sensor section 103A according to the third exemplary embodiment;

FIG. 20A and FIG. 20B are graphs that show the sensitivity characteristic of the sensor section 103B according to the third exemplary embodiment;

FIG. 21 is a graph that shows the sensitivity characteristic of the pixel according to the third exemplary embodiment;

FIG. 22 is a plan view showing the configuration of the radiation detector according to a fourth exemplary embodiment;

FIG. 23 is an equivalent circuit diagram which is paid attention to one pixel of the radiation detector according to the fourth exemplary embodiment;

FIG. 24A and FIG. 24B are graphs that show the sensitivity characteristic of the sensor section 103A according to the fourth exemplary embodiment;

FIG. 25A and FIG. 25B is a graph that shows the sensitivity characteristic of the sensor section 103B according to the fourth exemplary embodiment;

FIG. 26 is a graph that shows the sensitivity characteristic of the pixel according to the fourth exemplary embodiment;

FIG. 27 is a plan view showing the configuration of the radiation detector according to other embodiment; and

FIG. 28 is a graph that shows the sensitivity characteristic of the conventional pixel.

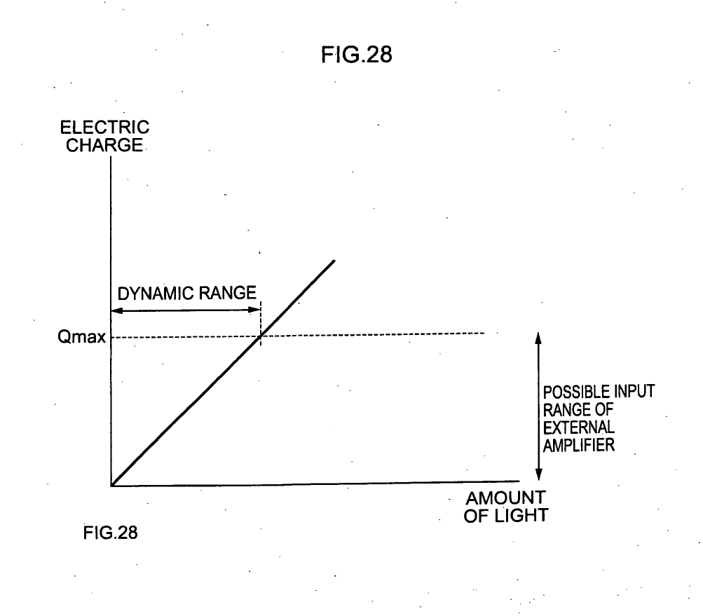

### DETAILED DESCRIPTION OF THE INVENTION

Hereinafter, exemplary embodiments for carrying out the present invention will be described with reference to the drawings.

### First Exemplary Embodiment

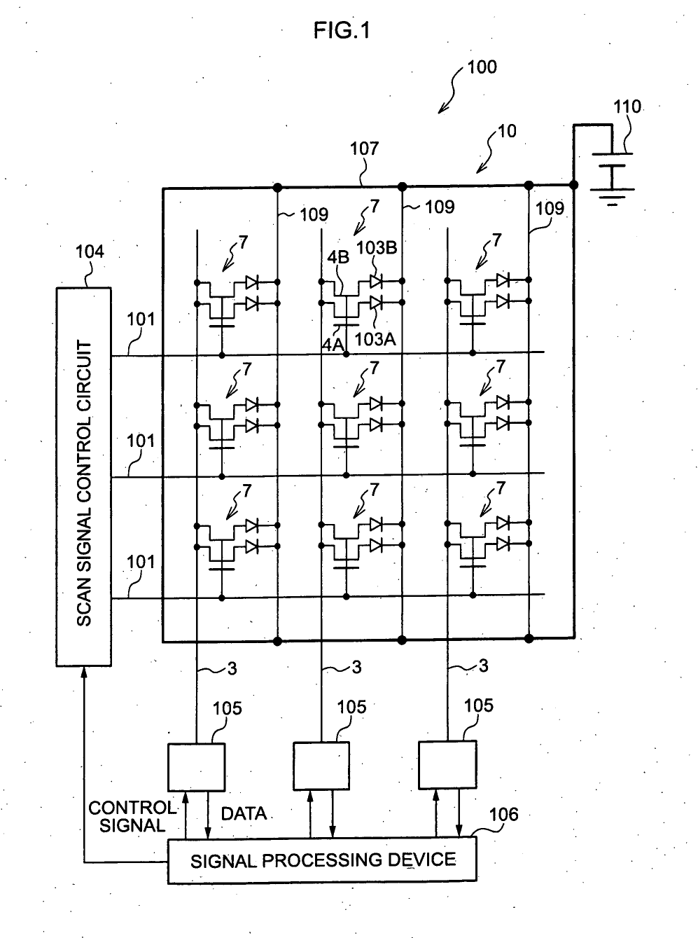

FIG. 1 illustrates an overall configuration of a radiographic imaging apparatus 100 according to the first exemplary embodiment.

As shown in FIG. 1, the radiographic imaging apparatus 100 according to the first exemplary embodiment includes an indirect-conversion-type radiation detector 10.

The radiation detector 10 is provided with plural pixels 7 disposed along one direction (the across direction in FIG. 1, referred to below as the “row direction”) and a direction that intersects with the row direction (the vertical direction in FIG. 1, referred to below as the “column direction”) so as to form a 2-dimensional shape. Each of the pixels 7 is configured to include two sensor sections 103A and 103B and TFT switches 4A and 4B. The two sensor sections 103A and 103B accumulate charges due to light illuminated from the scintillator. The TFT switches 4A and 4B respectively readout the charges accumulated in the sensor sections 103A and 103B. In the first exemplary embodiment, gate electrodes of the TFT switches 4A and 4B are formed to be in common. The sensor sections 103A and 103B have different sensitivity characteristics, which will be described later.

The radiation detection device 10 is provided with plural scan lines 101 that run parallel to each other along the row direction, and that switch the TFT switches 4A and 4B ON/OFF. The radiation detection device 10 is also provided with plural signal lines 3 that run parallel to each other along the row direction, and that read out the charges accumulated in the sensor sections 103A and 103B. Further, common electrode lines 109 are provided in the radiation detector 10 running parallel to the signal lines 3.

In the radiation detector 10, a line 107 is provided to surround the peripheral portion of the detection region where the pixels 7 are provided two-dimensionally, and is connected with a power source 110 that supplies a specific bias voltage. Both ends of each of the common electrode lines 109 are connected to the line 107. The sensor sections 103A and 103B of each of the pixel 7 are connected to the common electrode lines 109, and are supplied with bias voltage via the common electrode lines 109 and the line 107.

An electric signal, corresponding to amount of accumulated charges accumulated in the sensor sections 103A and 103B flows through each of the signal lines 3, by switching ON the TFT switches 4A and 4B of one of the pixels 7 connected to the signal lines 3. Signal detection circuits 105 are connected to each of the signal lines 3 for detecting the electrical signal flowing out from each of the signal lines 3. A scan signal control circuit 104 is also connected to the scan lines 101 for outputting a control signal to each of the scan lines 101 for ON/OFF switching of the TFT switches 4A and 4B.

The signal detection circuits 105 are each inbuilt with an amplifier circuit for each of the respective signal lines 3, and the amplifier circuits amplify input electrical signals. Electrical signals input by each of the signal lines 3 are amplified by the amplifier circuits in the signal detection circuits 105. The signal detection circuits 105 thereby detect the charge amount that has been accumulated in each of the sensor sections 103A and 103B as information for each pixel representing an image.

A signal processing device 106 is connected to the signal detection circuits 105 and the scan signal control circuit 104. The signal processing device 106 executes specific processing on the electrical signals detected by the signal detection circuits 105. The signal processing device 106 also outputs a control signal expressing the timing of signal detection to the signal detection circuits 105, and outputs a control signal expressing the timing of scan signal output to the scan signal control circuit 104.

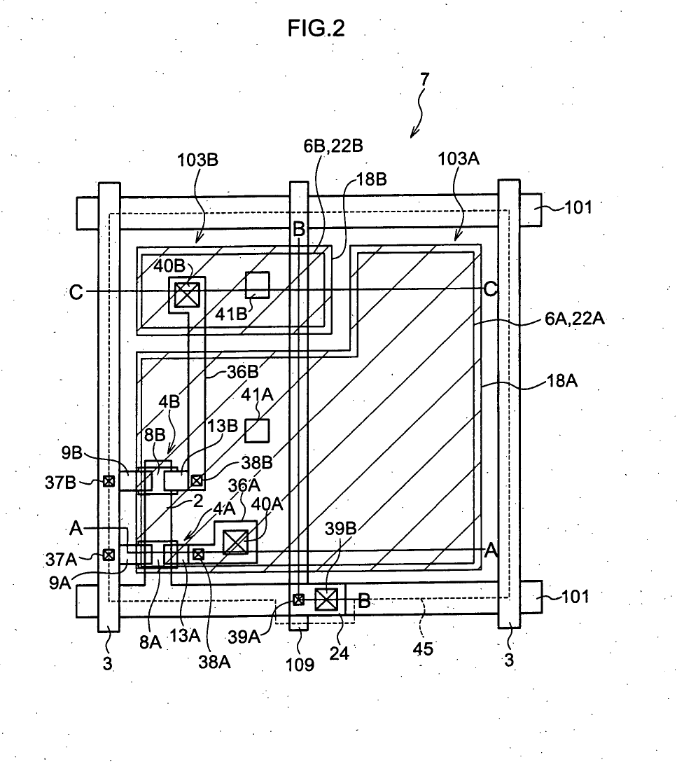

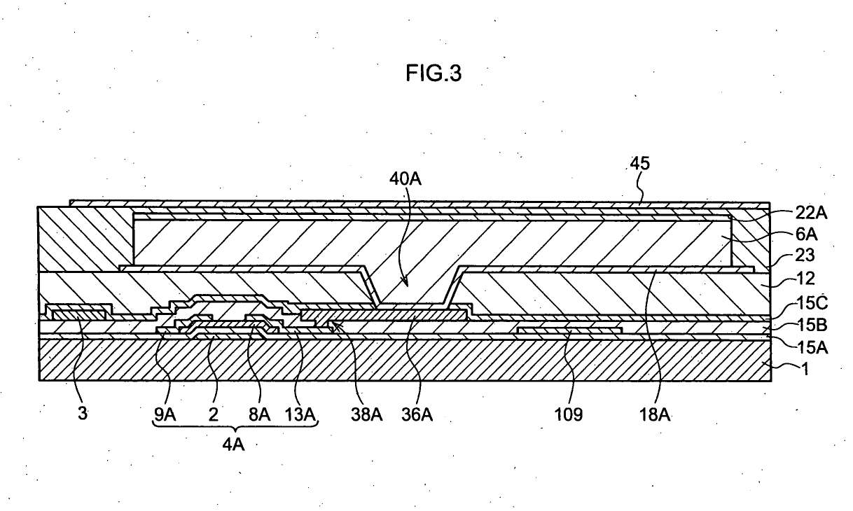

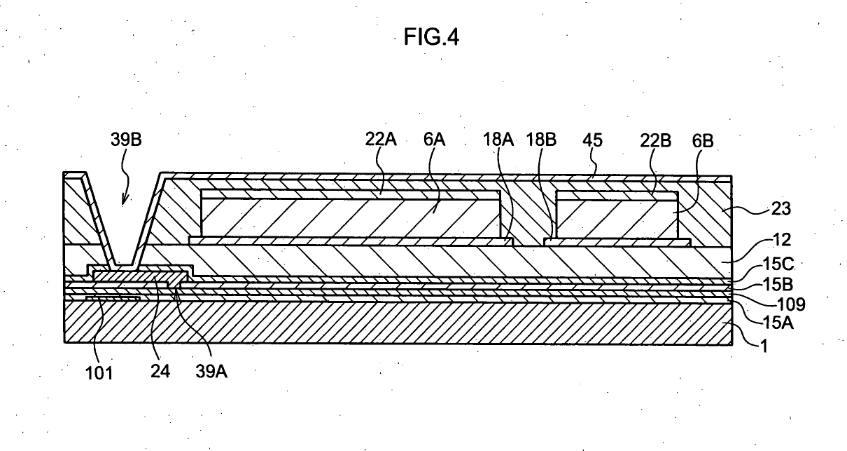

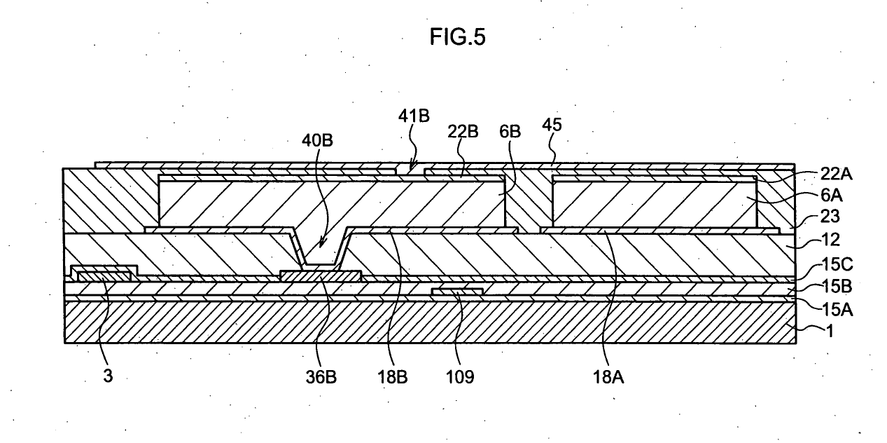

FIG. 2 to FIG. 5 show an example of a configuration of the radiation detector 10 according to the present exemplary embodiment. FIG. 2 illustrates in plan view the structure of a single pixel 7 of the radiation detector 10 according to the present exemplary embodiment. FIG. 3 shows a cross-section taken on line A-A of FIG. 2. FIG. 4 shows a cross-section taken on line B-B of FIG. 2. FIG. 5 shows a cross-section taken on line C-C of FIG. 2.

As shown in FIG. 3 to FIG. 5, the radiation detector 10 of the present exemplary embodiment is formed with an insulating substrate 1 configured from alkali-free glass or the like, on which the scan lines 101, and gate electrodes 2 are formed. The scan lines 101 and the gate electrodes 2 are connected together (see FIG. 2). The wiring layer in which the scan lines 101 and the gate electrodes 2 are formed (this wiring layer is referred to below as the first signal wiring layer) is formed from Al and/or Cu, or a layered film mainly composed of Al and/or Cu. However, the material of the first signal wiring layer is not limited thereto.

A first insulation film 15A is formed above the scan lines 101 and the gate electrodes 2 on one face of the first signal wiring layer, so as to cover the scan lines 101 and the gate electrodes 2. The locations of the first insulation film 15A positioned over the gate electrodes 2 are employed as a gate insulation film in the TFT switches 4A and 4B. The first insulation film 15A is, for example, formed from SiNx or the like by, for example, Chemical Vapor Deposition (CVD) film forming.

Island shape semiconductor active layers 8A and 8B is formed above the first insulation film 15A on each of the gate electrodes 2. The semiconductor active layers 8A and 8B are channel portions of the TFT switches 4A and 4B, and are, for example, formed from an amorphous silicon film.

Source electrodes 9A and 9B, and drain electrodes 13A and 13B are formed above the aforementioned layer. The wiring layer in which the source electrodes 9A and 9B, and the drain electrodes 13A and 13B are formed also has the common electrode lines 109 formed therein. The wiring layer in which the signal lines 3, the source electrodes 9A and 9B and the common electrode lines 109 are formed (this wiring layer is referred to below as the second signal wiring layer) is formed from Al and/or Cu, or a layered film mainly composed of Al and/or Cu. However, the material of the second signal wiring layer is not limited thereto.

A contact layer (not shown) is formed between the source electrodes 9A, the drain electrodes 13A, and the semiconductor active layer 8A, and between the source electrodes 9B, the drain electrodes 13B, and the semiconductor active layer 8B. The contact layer is an impurity doped semiconductor layer of, for example, impurity doped amorphous silicon or the like. The TFT switches 4A are configured by the gate electrodes 2, the semiconductor active layer 8A, the source electrodes 9A and the drain electrodes 13A. Further, the TFT switches 4B are configured by the gate electrodes 2, the semiconductor active layer 8B, the source electrodes 9B and the drain electrodes 13B.

A second insulation film 15B is formed over substantially the whole surface (substantially the entire region) of regions where the pixels 7 are situated above the substrate 1, so as to cover the semiconductor active layers 8A and 8B, the source electrodes 9A and 9B, the drain electrodes 13A and 13B, and the common electrode lines 109. The second insulation film 15B is formed, for example, from SiNx or the like, by, for example, CVD film forming.

The signal lines 3, contacts 24, and contacts 36A and 36B are formed above the second insulation film 15B. The wiring layer in which the signal lines 3, the contact 24 and the contacts 36A and 36B are formed (referred to below as a third signal wiring layer) is formed from Al and/or Cu, or a layered film mainly composed of Al and/or Cu. However, the material of the third signal wiring layer is not limited thereto.

Contact holes 37A and 37B (see FIG. 2) are formed in the second insulation film 15B at locations where the signal lines 3 and the source electrodes 9A, 9B face each other. Contact holes 38A are formed in the second insulation film 15B at locations where the contacts 36A and the drain electrodes 13A face each other. Further, contact holes 38B are formed in the second insulation film 15B at locations where the contacts 36B and the drain electrodes 13B face each other. Furthermore, contact holes 39A are also formed in the second insulation film 15B at locations where the contacts 24 and the common electrode lines 109 face each other.

The signal lines 3 are connected to the source electrodes 9A through the contact holes 37A, and are connected to the source electrodes 9B through the contact holes 37B (refer to FIG. 1). The contacts 36A are connected to the drain electrodes 13A through the contact holes 38A. Further, the contacts 36B are connected to the drain electrodes 13B through the contact holes 38B. Further, the contacts 24 are connected to the common electrode lines 109 through the contact holes 39A.

A third insulation film 15C is also formed on one face above the third signal wiring layer, with a coated interlayer insulation film 12 further formed thereon. The third insulation film 15C is formed, for example, from SiNx or the like by, for example, CVD film forming. Contact holes 40A are formed through both the interlayer insulation film 12 and the third insulation film 15C at locations facing the contacts 36A. Contact holes 40B are formed through both the interlayer insulation film 12 and the third insulation film 15C at locations facing the contacts 36B. Contact holes 39B are also formed through both the interlayer insulation film 12 and the third insulation film 15C at locations facing the contacts 24.

On the interlayer insulating film 12, lower electrodes 18A are formed so as to fill the respective contact holes 40A, and lower electrodes 18B are formed so as to fill the respective contact holes 40B. The lower electrodes 18A are connected to the contact 36A through the contact holes 40A, and are connected to the drain electrodes 13A of the TFT switches 4A through the contacts 36A. Further, the lower electrodes 18B are connected to the contacts 36B through the contact holes 40B, and are connected to the drain electrodes 13B of the TFT switches 4B through the contacts 36B. When semiconductor layers 6A and 6B, described later, are about 1 μm thick, there is substantially no limitation to the material of the lower electrodes 18A and 18B, as long as it is a conductive material. The lower electrodes 18A, 18B, are therefore formed with a conductive metal, such as an aluminum based material, ITO or the like.

However, when the film thickness of the semiconductor layers 6A and 6B are thin (about 0.2 μm to 0.5 μm) there is insufficient light absorption by the semiconductor layers 6A and 6B. Accordingly, in order to prevent an increase in leak current flow due to light illumination onto each of the TFT switches 4A and 4B, the lower electrodes 18A and 18B are preferably an alloy or layered film with a metal having light-blocking ability as a main component.

The semiconductor layer 6A that functions as a photodiode is formed on the lower electrode 18A. Further, the semiconductor layer 6B is formed on the lower electrode 18B. In the present exemplary embodiment, the photodiode of PIN structure is employed as the semiconductor layers 6A and 6B. Therefore, the semiconductor layers 6A and 6B are formed from the bottom with an n+ layer, an i layer and a p+ layer layered on each other. Note that in the present exemplary embodiment, the lower electrodes 18A and 18B are formed larger than the respective semiconductor layers 6A and 6B portions. When the thickness of the semiconductor layers 6A and 6B are thin (for example 0.5 μm or less), the TFT switches 4A and 4B are preferably covered with a metal having light-blocking ability, in order to prevent light from being incident onto the TFT switches 4A and 4B.

A separation of 5 μm or greater is preferably secured from the channel of each of the TFT switches 4A and 4B to the edge of the light-blocking metal lower electrodes 18A and 18B, in order to suppress light entry to the TFT switches 4A and 4B due to light scattering and reflection within the device.

Upper electrodes 22A and 22B are formed on each of the semiconductor layers 6A and 6B respectively. The upper electrodes 22A and 22B are, for example, formed using a material having high transmissivity to light, such as ITO, Indium Zinc Oxide (IZO) or the like.

In the radiation detector 10 according to the present exemplary embodiment, the upper electrodes 22A, the semiconductor layer 6A, and the lower electrodes 18A configure the sensor sections 103A. Further, in the radiation detector 10 according to the present exemplary embodiment, the upper electrodes 22B, the semiconductor layer 6B, and the lower electrodes 18B configure the sensor sections 103B. Further, the radiation detector 10 according to the present exemplary embodiment is configured so that the sizes of the sensor sections 103A and the sensor sections 103B are different, and light-receiving areas thereof are distinct. Accordingly, the sensitivity characteristics of the sensor sections 103A and the sensor sections 103B are different. Specifically, in the radiation detector 10 according to the present exemplary embodiment, about 80% of the pixel region is the region of the sensor section 103A, and about 20% of pixel region is the region of the sensor section 103B. Accordingly, in the radiation detector 10 according to the present exemplary embodiment, the light-receiving areas of the sensor sections 103A and the sensor sections 103B are formed to be different for about four times.

On the interlayer insulation film 12 and the upper electrodes 22A and 22B, coated interlayer insulating film 23 is formed so as to cover the semiconductor layers 6A and 6B. At a portion that corresponds to the upper electrodes 22A and 22B, the interlayer insulation film 23 has openings 41A and 41B, respectively. In the interlayer insulating film 23, contact holes 39B are formed at a portion that corresponds to the contacts 24.

Electrodes 45 are formed on the interlayer insulation film 23 so as to cover the pixel regions. The electrodes 45 are, for example, formed using a material that have high transmissive to light, such as ITO, IZO or the like. The electrodes 45 are connected to the upper electrodes 22B through the openings 41A and are also connected to the contacts 24 through the contact holes 39B. Accordingly, the upper electrodes 22A and 22B are electrically connected to the common electrode lines 109 through the contacts 24 and the electrodes 45.

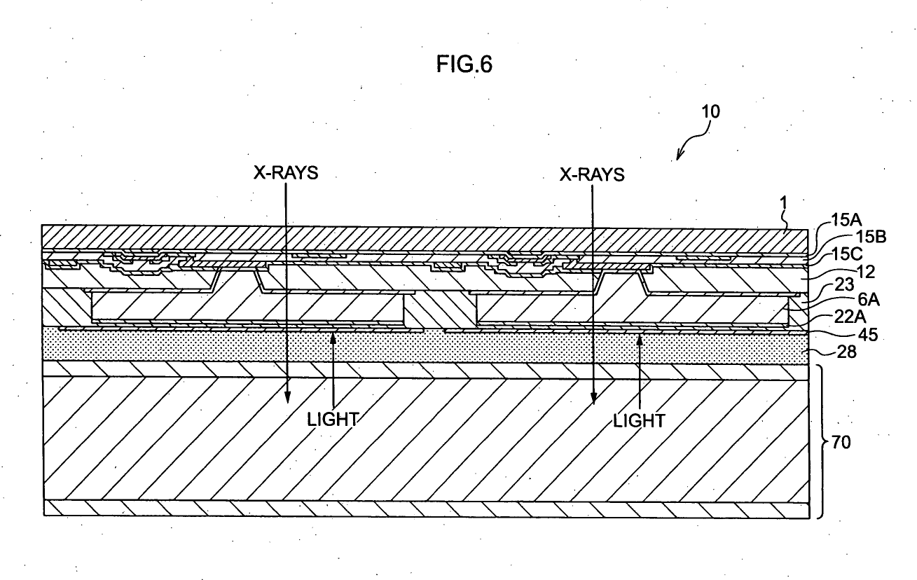

In a radiation detector 10 configured as described, a protection layer 28, as shown in FIG. 6, may be formed from an insulating material with low light absorption characteristics as required. A scintillator 70, configured for example from GOS or the like, may then be attached using an adhesive resin with low light absorption characteristics to the surface of the protection layer 28. The scintillator 70 converts irradiated radiation into light, and emits the light. As shown in FIG. 6, a reflective body made from a material that reflects light is provided at a lower portion of the scintillator 70 in the present exemplary embodiment.

Explanation now follows regarding the principles of operation of the radiographic imaging apparatus 100 configured as described above.

When X-rays are irradiated from above in FIG. 6, the irradiated X-rays are absorbed by the scintillator 70 and are converted into visible light. Note that the X-rays may also be irradiated from below in FIG. 6. In such cases, the irradiated X-rays are absorbed by the scintillator 70 and are converted into visible light. The generated light passes through the protection layer 28 of adhesive resin; and is illuminated onto the respective sensor sections 103A and 103B respectively.

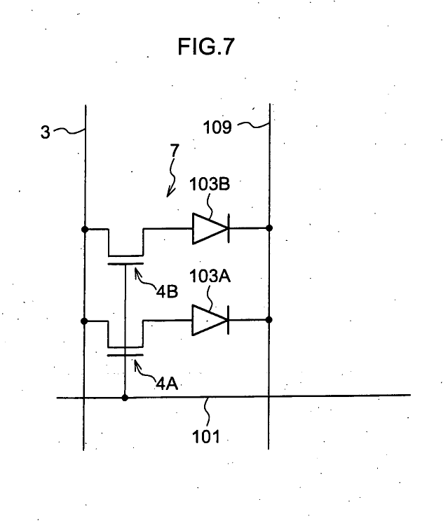

FIG. 7 illustrates an equivalent circuit diagram focusing on one of the pixels 7 of the radiation detector 10 according to the first exemplary embodiment.

A predetermined bias voltage is applied to the sensor sections 103A and 103B through the common electrode lines 109, and the charges are generated upon illumination of light. The charges generated at the semiconductor layers 6A and 6B are collected by the lower electrodes 18A and 18B. The sensor sections 103A and 103B are connected to the TFT switches 4A and 4B respectively. When detecting an image, the gate electrodes 2 of the TFT switches 4A and 4B are applied with negative bias, and the TFT switches 4A and 4B are held in OFF state and the charges collected in the lower electrodes 18A, 18B are accumulated.

When reading the image, ON signal (from +10V to +20V) is sequentially applied to each of the scan lines 101. Due thereto, the TFT switches 4A and 4B of the respective pixels 7 are turned ON for each row, and the electric signals, according to the charge amount accumulated in the lower electrodes 18A and 18B, flow through the respective signal lines 3. The signal detecting circuits 105 detect the charge amount accumulated in the sensor sections 103A and 103B of the respective pixels 7 as information that represents the image, based on the electric signals that flow through each of the signal lines 3. This allows the radiation detector 10 to obtain image information represented by the irradiated X-rays.

Here, the radiation detector 10 according to the present exemplary embodiment is provided with the sensor section 103A and 103B for each respective pixel 7. Further, as shown in FIG. 2, in the radiation detector 10 according to the present exemplary embodiment, the sizes of the sensor sections 103A and 103B differs, and therefore, the sensitive characteristics thereof also differs. Especially, in the present exemplary embodiment, the sensor section 103A has a light-receiving area which is four times larger than that of the sensor section 103B.

In the sensor sections 103A and the sensor sections 103B, charges are accumulated linearly corresponding to the amount of the illuminated light. Next, electric potentials of the upper electrodes 22A and 22B increase according to the accumulation of the charges. Further, accumulation of the charges saturate when the electric potential of the upper electrodes 22A and 22B become the electric potential of the bias voltage.

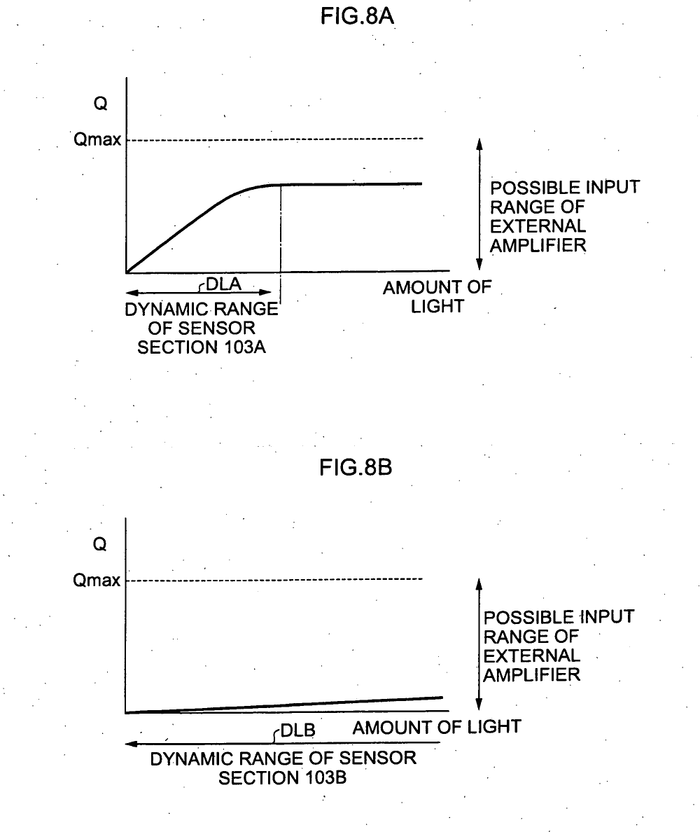

Since the sensor sections 103A have a larger light receiving area, the amount of accumulated charge for the amount of the received light is large, as shown in FIG. 8A, and the accumulated charges becomes saturated earlier. Note that a range DLA until the accumulation of charges becomes saturated is the dynamic range of the sensor sections 103A.

On the other hand, since the sensor sections 103B have a smaller light-receiving area, the amount of accumulated charge for the amount of the received light is small, as shown in FIG. 8A, and the accumulated charges becomes saturated slower. Note that a range DLB until the accumulation of charges becomes saturated is the dynamic range of the sensor sections 103B.

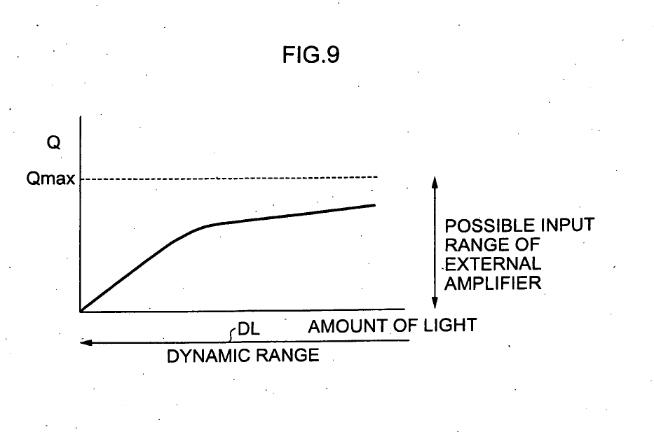

In each of the pixels 7, the charges are individually accumulated in the sensor sections 103A and 103B correspondingly to the received amount of the light. Next, when the TFT switches 4A and 4B are turned ON, the electric signal, which is combined charges that has been accumulated in the sensor section 103A and the sensor section 103B, flows through the signal line 3, as shown in FIG. 9.

As described above, the present exemplary embodiment may implement the output characteristics of each pixel to be nonlinearly curved, by differentiating the sensitivity characteristics of the sensor sections 103A and the sensor sections 103B, as shown in FIG. 9. Accordingly, by the sensitivity characteristics of the sensor sections 103A, the sensitivity to light to in the low radiation amount region may be increased. On the other hand, in a high radiation amount region, since the charges can be accumulated in the sensor sections 103B even when the charges accumulated in the sensor sections 103A become saturated, the increasing amount of the charges in the high radiation amount region is small. Accordingly, the radiation detector 10 according to the present exemplary embodiment may match the electric signals within a range of the amplifier, without narrowing the dynamic range DL.

As described above, according to the present exemplary embodiment, by providing the sensor sections 103A and 103B that have different sensitivity characteristics to each of the pixels 7, the output characteristics of the electric signals that are output from each of the pixels 7 can be set to a nonlinear curve. Accordingly, the radiation detector 10 according to the present exemplary embodiment may suppress a decrease in dynamic range, and may improve an S/N ratio at a low radiation amount.

Furthermore, the sensor sections 103A and 103B are formed in the same layer, in the present exemplary embodiment. Therefore, the radiation detector 10 according to the present exemplary embodiment may suppress variations in the film thickness of the sensor sections 103A and 103B. Accordingly, the radiation detector 10 according to the present exemplary embodiment may adjust the difference of the sensitivity characteristics in the respective sensors, for example, by selecting a light receiving area of the respective sensor sections.

### Second Exemplary Embodiment

Next, the second exemplary embodiment will be described. Noted that the configurations similar to those in the first exemplary embodiment will be given with the same references, and description thereof will be omitted.

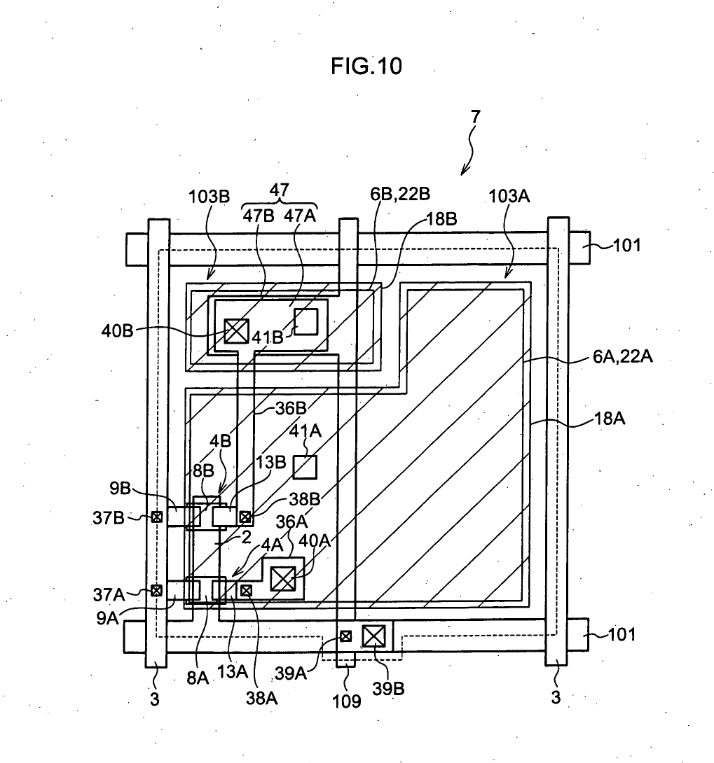

FIG. 10 illustrates a plan view showing the configuration of one pixel 7 in the radiation detector 10 according to the second exemplary embodiment.

In the radiation detector 10, electrode portions 47A are formed by widely forming the contacts 36B at a part of the sensor sections 103B. Further, in the radiation detector 10, electrode portions 47B are formed by widely forming the common electrode lines 109 at a part of the sensor sections 103B, so as to face the electrode portions 47A. Accordingly, in the radiation detector 10, charge storage capacitors 47 are formed by the electrode portions 47A and the electrode portions 47B.

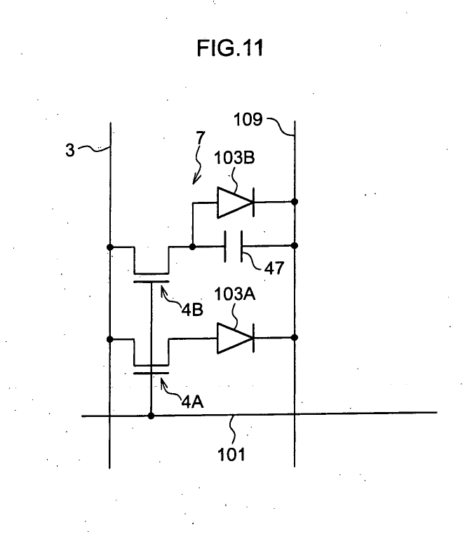

FIG. 11 illustrates an equivalent circuit diagram of one pixel 7 in the radiation detector 10 according to the second exemplary embodiment.

The charge storage capacitors 47 are connected parallel to the sensor sections 103B in the radiation detector 10 according to the second exemplary embodiment.

Accordingly, in the radiation detector 10 of the present exemplary embodiment, the sizes of the sensor sections 103A and 103B are configured to be different, and the charge storage capacitors 47 are provided parallel to the sensor sections 103B.

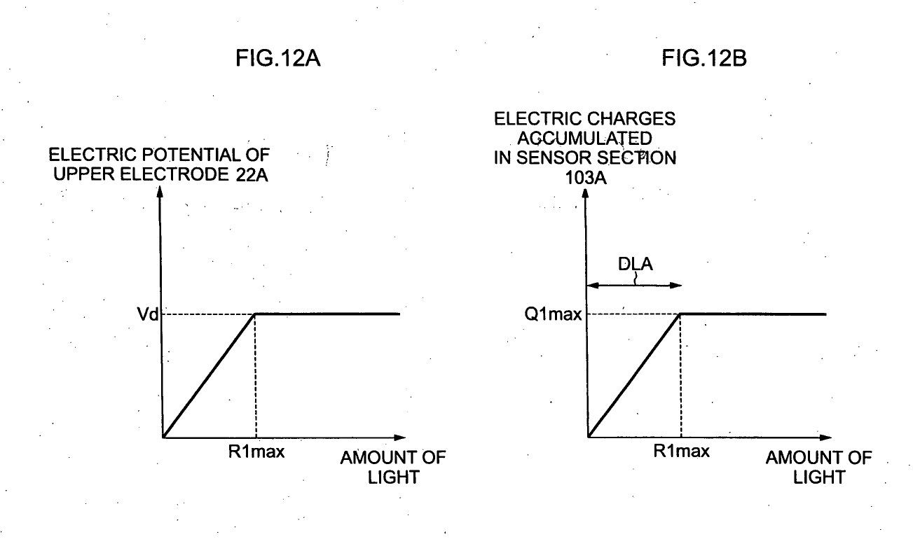

Since the sensor sections 103A have larger light receiving area, the amount of charges accumulated to amount of the light received becomes large. Therefore, the charges are linearly accumulated according to amount of illuminated light, and the electric potential of the upper electrodes 22A increases according to the accumulated charges as shown in FIG. 12A. Thereafter, accumulated charges become saturated as shown in FIG. 12B, when the electric potential of the upper electrodes 22A become the potential of the bias voltage Vd. Note that a range DLA until the accumulation of charges becomes saturated is the dynamic range of the sensor sections 103A.

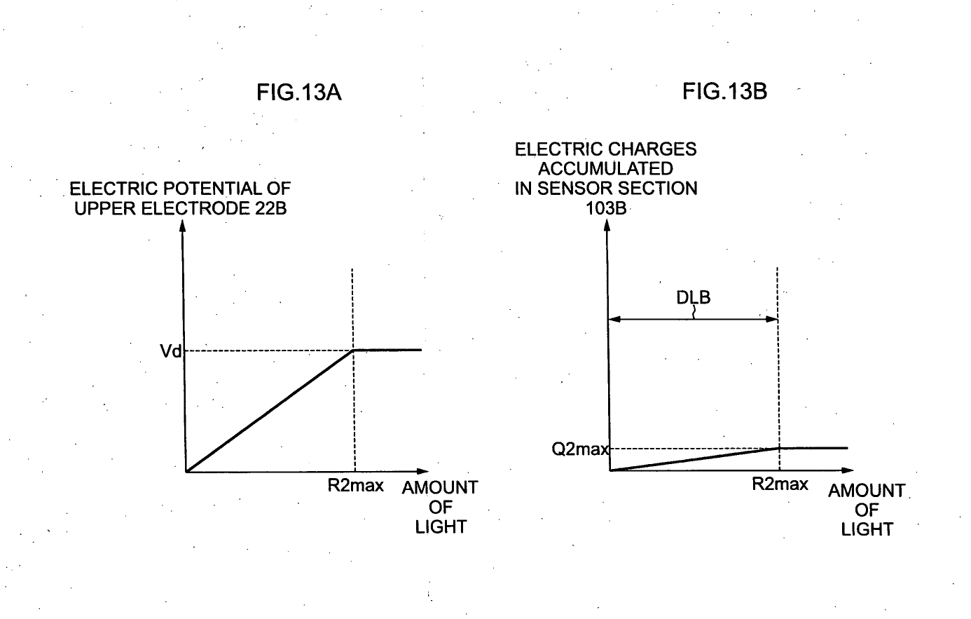

On the other hand, the sensor sections 103B have smaller light receiving area, and the charge storage capacitors 47 are connected in parallel. Due thereto, the electric potential of the upper electrodes 22B gently increases according to the accumulated charges as shown in FIG. 13A. Further, accumulated charges become saturated as shown in FIG. 13B, when the electric potential of the upper electrodes 22B become the potential of the bias voltage Vd. Note that a range DLB until the accumulation of charges becomes saturated is the dynamic range of the sensor sections 103B.

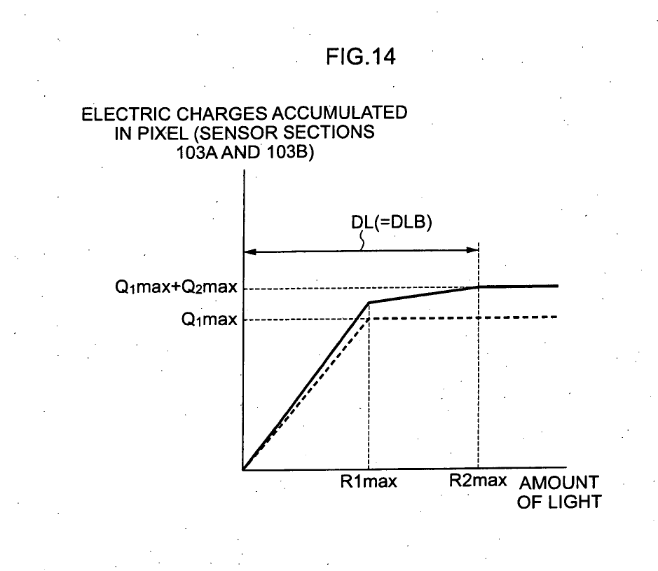

In each of the pixels 7, the charges are individually accumulated in the sensor sections 103A and 103B, correspondingly to the received amount of the light. Next, when the TFT switches 4A and 4B are turned ON, the electric signal, which is combined charges that has been accumulated in the sensor sections 103A and the sensor sections 103B, flows through the signal line 3, as shown in FIG. 14.

As described above, the present exemplary embodiment may implement the output characteristics of each pixel to be curved, by differentiating the sensitivity characteristics of the sensor sections 103A and the sensor sections 103B, as shown in FIG. 14. Accordingly, the radiation detector 10 according to the present exemplary embodiment may match the electric signals within a range of the amplifier, without narrowing the dynamic range DL.

As described above, according to the present exemplary embodiment, by providing the sensor sections 103A and 103B that have different sensitivity characteristics to each of the pixels 7, the output characteristics of the electric signals that are output from each of the pixels 7 can be set to a nonlinear curve. Accordingly, the radiation detector 10 according to the present exemplary embodiment may suppress a decrease in dynamic range, and may improve an S/N ratio at a low radiation amount.

Accordingly, by providing the charge storage capacitors 47 under the sensor sections 103A and 103B, the present exemplary embodiment may largely differentiate the sensitivity characteristics in each of the sensor sections, without reducing the light receiving areas of the sensor sections 103A and 103B, when compared to a case in which the charge storage capacitor 47 does not exist. Accordingly, the present exemplary embodiment may suppress a decrease in dynamic range.

### Third Exemplary Embodiment

Next, the third exemplary embodiment will be described. Note that the configurations similar to those in the first exemplary embodiment will be given with the same references, and description thereof will be omitted.

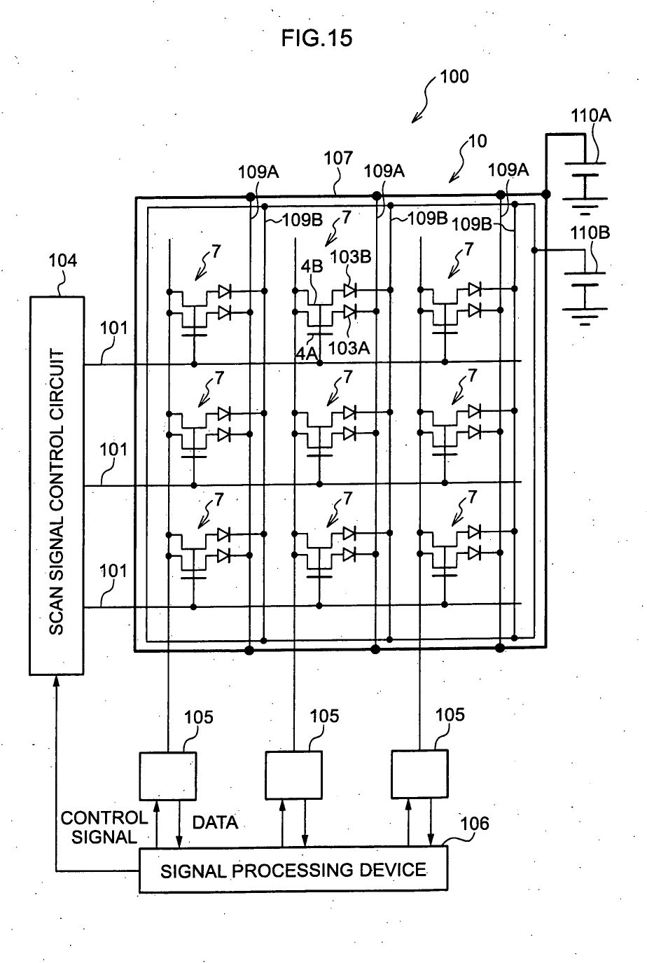

FIG. 15 shows an entire configuration of the radiation detector 10 according to the third exemplary embodiment.

In the radiation detector 10 according to the third exemplary embodiment, common electrode lines 109A and 109B are provided parallel for each signal line 3.

Further, in the radiation detector 10, the lines 107A and 107B are provided so as to surround the peripheral portion of the detection region in which the pixels 7 are provided two dimensionally. The line 107A is connected to the power supply 110A, and the line 107B is connected to the power supply 110B. Both ends of the common electrode lines 109A are connected to the line 107A, and bias voltage is supplied to the common electrode lines 109A via the line 107A from the power supply 110A. Further, the both ends of the common electrode line 109B are connected to the line 107B, and bias voltage is supplied to the common electrode line 109B via the line 107B from the power supply 110B.

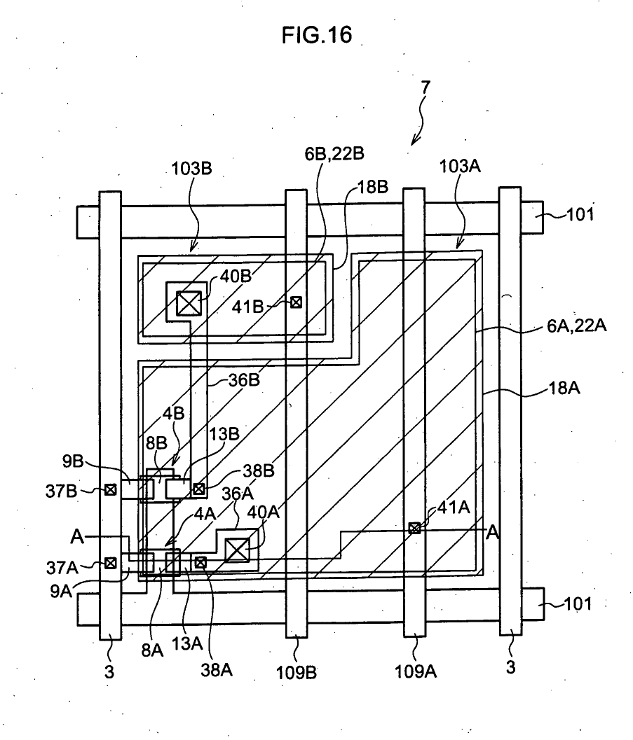

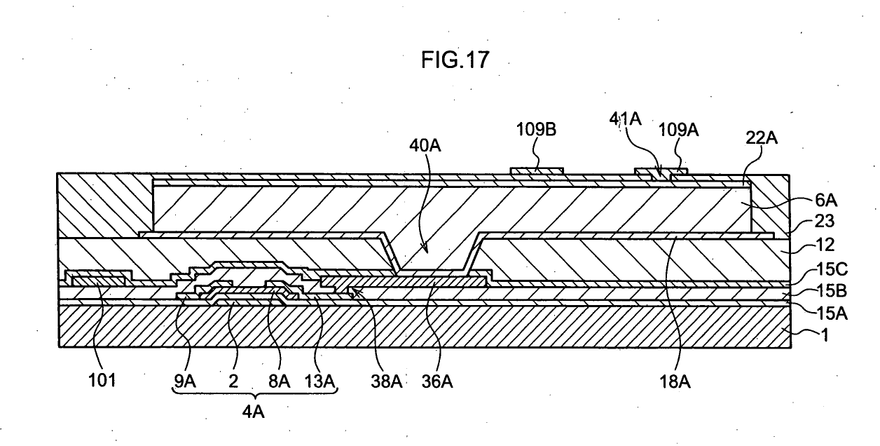

FIG. 16 and FIG. 17 show an example of the radiation detector 10 according to the third exemplary embodiment. FIG. 16 illustrates a plan view showing the configuration of one pixel 7 in the radiation detector 10 according to the present exemplary embodiment. FIG. 17 illustrates a cross-sectional view taken along the line A-A of FIG. 16.

In the radiation detector 10 according to the present exemplary embodiment, the common electrode lines 109A and the common electrode lines 109B are formed on the interlayer insulating film 23. The common electrode lines 109A are electrically connected with the upper electrodes 22A through the openings 41A. Further, the common electrode lines 109B are electrically connected with the upper electrodes 22B through the openings 41B.

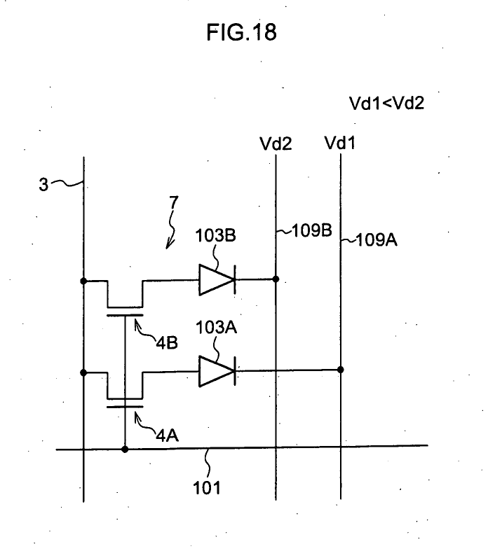

FIG. 18 illustrates an equivalent circuit diagram of one pixel 7 of the radiation detector 10 according to the third exemplary embodiment.

In the radiation detector 10 according to the third exemplary embodiment, the sizes of the sensor sections 103A and 103B are configured to be different, and the bias voltages supplied to the sensor sections 103A and 103B are configured to be different. In addition, bias voltage Vd1 is supplied to the sensor sections 103A through the common electrode lines 109A. Further, bias voltage Vd2 is supplied to the sensor sections 103B through the common electrode lines 109B.

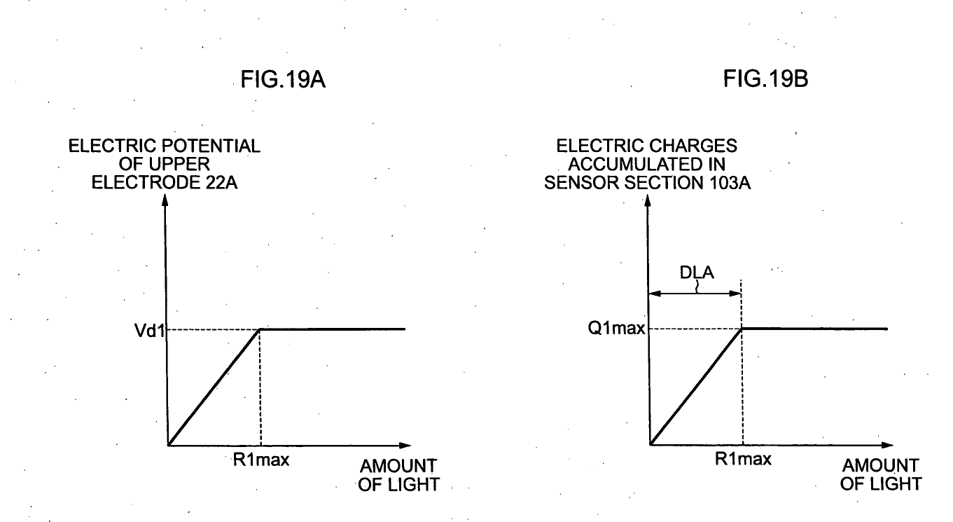

Since the sensor sections 103A have larger light receiving area, the amount of charges accumulated to amount of the light received becomes large. Therefore, the charges are linearly accumulated according to amount of illuminated light, and the electric potential of the upper electrodes 22A increase according to the accumulated charges, as shown in FIG. 19A. Thereafter, accumulated charges become saturated, as shown in FIG. 19B, when the electric potential of the upper electrodes 22A become the potential of the bias voltage Vd1. Note that a range DLA until the accumulation of charges becomes saturated is the dynamic range of the sensor sections 103A.

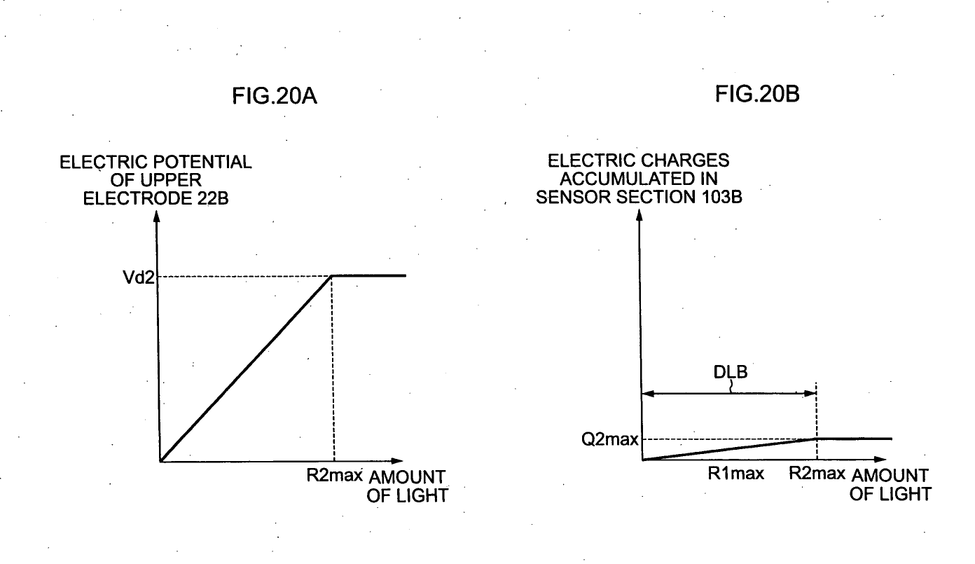

On the other hand, the sensor sections 103B have smaller light receiving area. Due thereto, the electric potential of the upper electrodes 22B gently increase according to the accumulated charges as shown in FIG. 20A. Further, accumulated charges become saturated, as shown in FIG. 20B, when the electric potential of the upper electrodes 22B become the potential of the bias voltage Vd2. Note that a range DLB until the accumulation of charges becomes saturated is the dynamic range of the sensor section 103B.

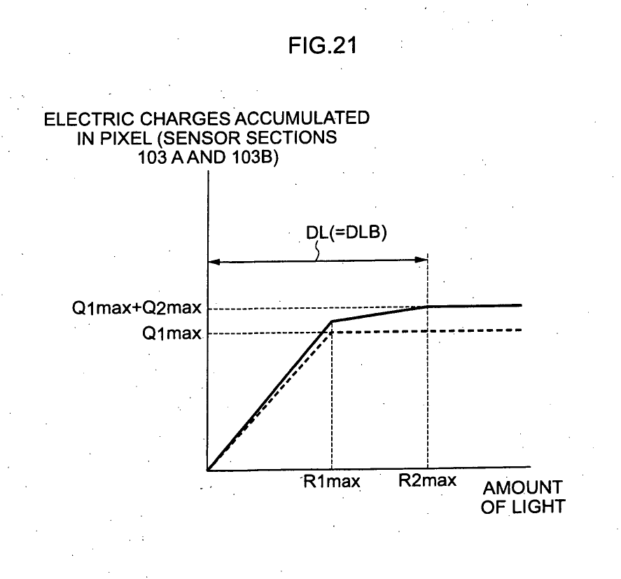

In each of the pixels 7, the charges are individually accumulated in the sensor sections 103A and 103B, correspondingly to the received amount of the light. Next, when the TFT switches 4A and 4B are turned ON, the electric signal, which is combined charges that has been accumulated in the sensor sections 103A and the sensor sections 103B, flows through the signal line 3, as shown in FIG. 21.

As described above, the present exemplary embodiment may implement the output characteristics of each pixel to be curved, by differentiating the sensitivity characteristics of the sensor sections 103A and the sensor sections 103B, as shown in FIG. 21. Accordingly, the radiation detector 10 according to the present exemplary embodiment may suppress a decrease in S/N ratio, and may improve the dynamic range, at a low radiation amount.

As described above, according to the present exemplary embodiment, by providing the sensor sections 103A and 103B that have different sensitivity characteristics to each of the pixels 7, the output characteristics of the electric signals that are output from each of the pixels 7 can be set to a nonlinear curve. Accordingly, the radiation detector 10 according to the present exemplary embodiment may suppress a decrease in dynamic range, and may improve an S/N ratio at a low radiation amount.

Further, according to the present exemplary embodiment, the bias voltage may be controlled from outside of the radiation detector 10. Due thereto, the present exemplary embodiment can arbitrarily change the value of the bias voltage applied to each sensor section according to its specification. Accordingly, the present exemplary embodiment can arbitrarily adjust the difference of the sensitivity characteristics of each of the sensor sections, by controlling bias voltage from the outside of the radiation detector 10, even if manufacture variation within the radiation detector 10 has occurred.

### Fourth Exemplary Embodiment

Next, the fourth exemplary embodiment will be described. Note that the configurations similar to those in the first exemplary embodiment will be given with the same references, and description thereof will be omitted.

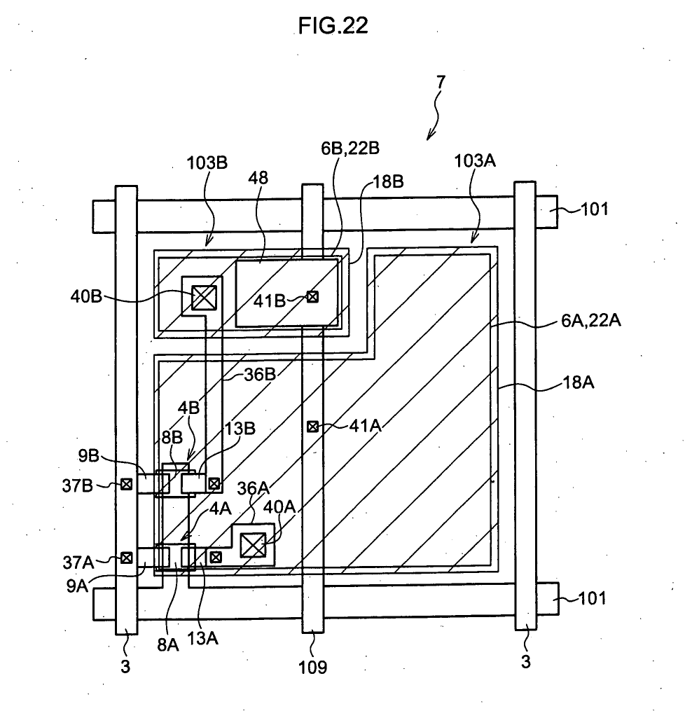

FIG. 22 illustrates a plan view showing the configuration of one pixel 7 in the radiation detector 10 according to the fourth exemplary embodiment.

In the radiation detector 10 according to the present exemplary embodiment, the common electrode lines 109 are formed on the interlayer insulating film 23, as the third exemplary embodiment. The common electrode lines 109 are electrically connected, to the upper electrodes 22A through the openings 41A, and are electrically connected to the upper electrodes 22B through the openings 41B.

Further, in the radiation detector 10 according to the present exemplary embodiment, a light blocking electrode portion 48 that protect a part of the each sensor section 103B from light is formed by widely forming the common electrode line 109 at a part of sensor section 103B.

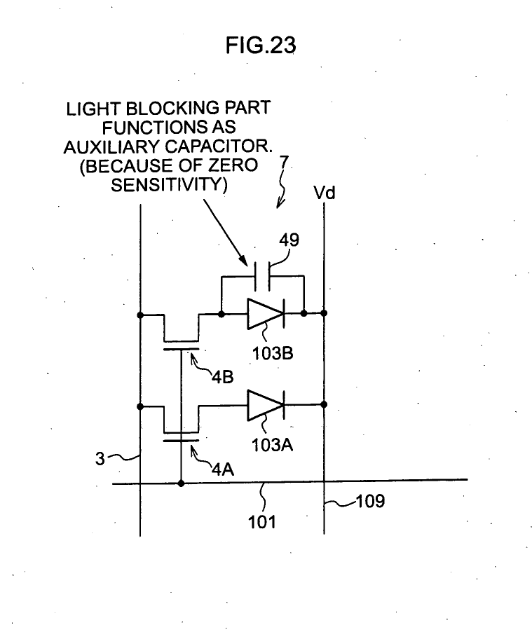

FIG. 23 illustrates an equivalent circuit diagram of one pixel 7 of the radiation detector 10 according to the fourth exemplary embodiment.

In the radiation detector 10 according to the fourth exemplary embodiment, a part of each sensor section 103B is protected from the light, by the light blocking electrode portion 48. Due thereto, the sensitivity of the part of the sensor section 103B, which is shaded from light, becomes zero, and the part shaded from light functions as an auxiliary capacitor 49 connected in parallel with the sensor section 103B.

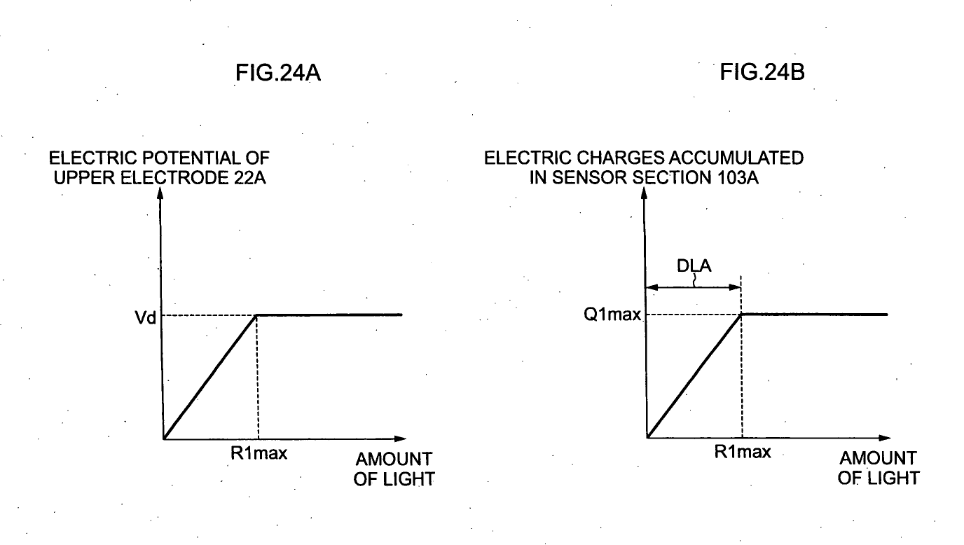

Since the sensor sections 103A have larger light receiving area, the amount of charges accumulated to amount of the light received becomes large. Therefore, the charges are linearly accumulated according to amount of illuminated light, and the electric potential of the upper electrodes 22A increases according to the accumulated charges as shown in FIG. 24A. Thereafter, accumulated charges become saturated as shown in FIG. 24B, when the electric potential of the upper electrodes 22A becomes the potential of the bias voltage Vd. Note that a range DLA until the accumulation of charges becomes saturated is the dynamic range of the sensor sections 103A.

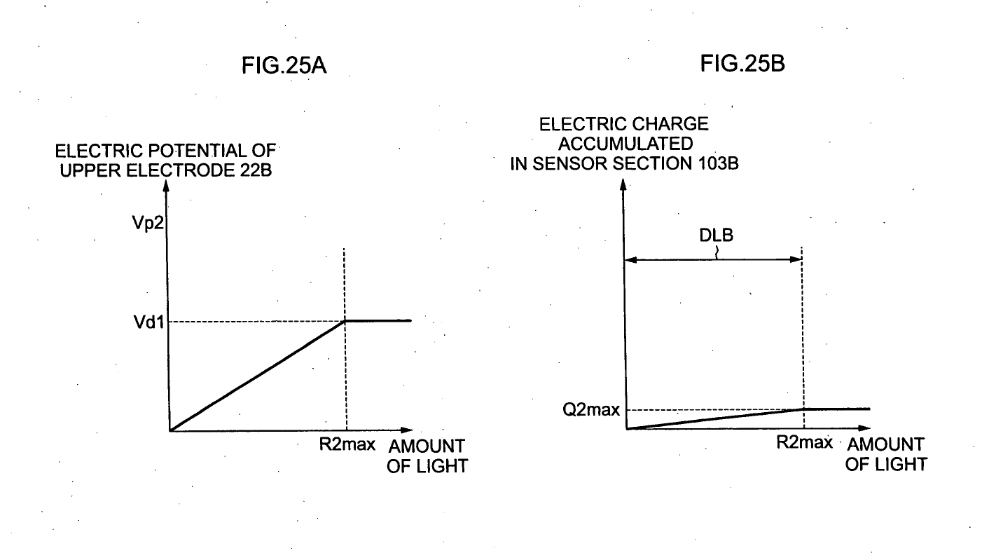

On the other hand, the sensor sections 103B have smaller light receiving area, and the auxiliary capacitors 49 are connected in parallel. Due thereto, the electric potential of the upper electrodes 22B gently increase according to the accumulated charges as shown in FIG. 25A. Further, accumulated charge becomes saturated as shown in FIG. 13B, when the electric potential of the upper electrodes 25B become the potential of the bias voltage Vd. Note that a range DLB until the accumulation of charges becomes saturated is the dynamic range of the sensor sections 103B.

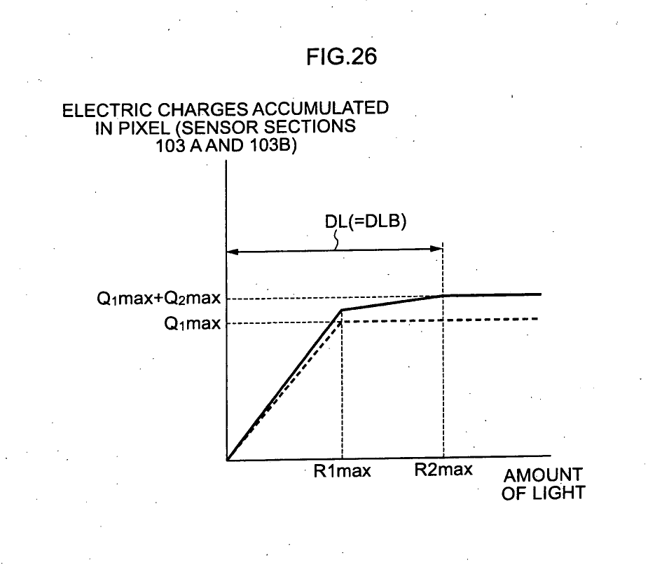

In each of the pixels 7, the charges are individually accumulated in the sensor sections 103A and 103B, correspondingly to the received amount of the light. Next, when the TFT switches 4A and 4B are turned ON, the electric signal, which is combined charges that has been accumulated in the sensor sections 103A and the sensor sections 103B, flows through the signal lines 3, as shown in FIG. 26.

As described above, the present exemplary embodiment may implement the output characteristics of each pixel to be curved, by differentiating the sensitivity characteristics of the sensor sections 103A and the sensor sections 103B, as shown in FIG. 26. Accordingly, the radiation detector 10 according to the present exemplary embodiment may suppress a decrease in S/N ratio, and may improve the dynamic range, at a low radiation amount.

As described above, according to the present exemplary embodiment, by providing the sensor sections 103A and 103B that have different sensitivity characteristics to each of the pixels 7, the output characteristics of the electric signals that are output from each of the pixels 7 can be set to a nonlinear curve. Accordingly, the radiation detector 10 according to the present exemplary embodiment may suppress a decrease in dynamic range, and may improve an S/N ratio at a low radiation amount.

Further, the present exemplary embodiment includes, in the same layer as the sensor section, the auxiliary capacitors 49 by shading a part of the sensor section from light. Therefore, the present exemplary embodiment can suppress manufacture variation, when compared with a case in which the auxiliary capacitors are provided in a layer different from the layer of the sensor section.

Note that the configuration of the radiographic imaging apparatus 100 and the configuration of the radiation detector 10 explained in the above exemplary embodiments are merely examples thereof, and obviously various modifications are possible within a scope not departing from the spirit of the present invention.

For example, in the above exemplary embodiments, a case in which the two sensor sections 103A are 103B are provided in each pixel 7, has been described. However, the present invention is not limited thereto. Two or more sensor sections may be provide in each pixel 7, and the output characteristic of the electric signal output from each pixel 7 may be changed in multistage manner.

In the above exemplary embodiments, a case in which the sensor sections 103A and the sensor sections 103B are formed in same layer, has been described. However, the present invention is not limited thereto. In an alternative exemplary embodiment, the sensor sections 103A and the sensor sections 103B may be formed in a different layer. When the pixel sizes are small, the rate between the insulated area between the two sensor sections and the area of the whole pixel becomes large. However, when the sensor sections are provided in a different layer, the sensor sections may also be provided in the insulated area between the two sensor sections, thereby the light-receiving areas becomes large. Accordingly, in the alternative exemplary embodiment, charge amount accumulated in each sensor section increases, and therefore, the alternative exemplary embodiment may suppress a decrease in a dynamic range.

In the above exemplary embodiments, a case in which the light-receiving areas of the sensor sections 103A and the sensor sections 103B differ for about four times, has been described. However, the present invention is not limited thereto. The light receiving areas of the sensor sections 103A and the sensor sections 103B may differ for four times or more. The sensitivity characteristic of the sensor sections 103A and the sensor sections 103B can be differentiated by the difference of the light-receiving areas between the sensor sections 103A and the sensor sections 103B.

In the above exemplary embodiments, a case in which the sensitivity characteristics of the sensor sections 103A and the sensor sections 103B are differentiated by differing the sizes of light-receiving areas of the sensor sections 103A and the sensor sections 103B, has been described. However, the present invention is not limited thereto. The difference in the sensitivity characteristic of the sensor sections 103A and the sensor sections 103B may be differed by using different materials in the semiconductor layers 6A and 6B.

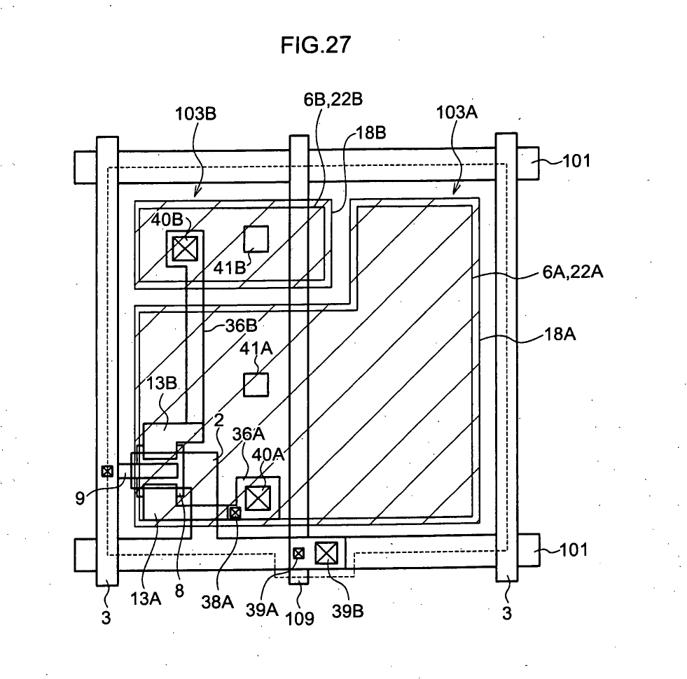

In the above exemplary embodiments, a case in which the gate electrodes 2 of the TFT switches 4A, 4B of each pixel 7 are formed to be in common, has been described. However, the present invention is not limited to thereto. In an alternative exemplary embodiment, the TFT switches 4A, 4B may be separated. For example, as shown in FIG. 27, source electrodes 9 as well as the gate electrodes 2 of the TFT switches 4A and 4B may be formed in common. In this case, it is possible to reduce the line connected to the signal line 3 in each pixel 7. Thus, the alternative exemplary embodiment may decrease parasitic capacitance of the signal lines 3.

In the above exemplary embodiments, a case in which the present exemplary embodiment is applied to the radiographic imaging apparatus 100 that detects an image by detecting X-rays, has been described. However, the present invention is not limited thereto. For example, radiation employed may be X-rays and also visible light, ultraviolet light, infrared light, gamma rays, or a particle beam.

What is claimed is:

1. A radiation detector comprising:
a plurality of pixels arranged two dimensionally in a detection region that detects radiation, each of the plurality of pixels including a plurality of sensor sections that generate electric charges in response to irradiation of radiation and accumulates electric charge in accordance with an amount of irradiated radiation, and a switch element for reading the electric charge, and respective sensor sections having different sensitivity characteristics;
a plurality of scan lines through each of which a control signal that switches respective switch elements flows; and
a plurality of signal lines, through each of which an electric signal corresponding to the electric charge accumulated in the respective sensor sections of each of the pixels flows, in accordance with a switching state of each of the respective switch elements.

2. The radiation detector according to claim 1, wherein each of the sensor sections has a different saturation value for an amount of electric charges accumulated in accordance with the amount of irradiated radiation.

3. The radiation detector according to claim 1, wherein each of the sensor sections is formed in the same layer and has a different size.

4. The radiation detector according to claim 1, further comprising an illumination section that is formed on the detection region and that generates light in response to the irradiated radiation,
wherein the sensor sections generate electric charges in response to illumination of light generated by the illumination section, and at least a portion of the sensor sections is shielded from light.

5. The radiation detector according to claim 1, further comprising a plurality of bias lines, each of which supplies a different bias voltage,
wherein an amount of electric charges that can be accumulated by each of the sensor sections varies in accordance with an applied bias voltage, and
wherein each of the sensor sections is applied with a different bias voltage via a different one of the plurality of bias lines.

6. The radiation detector according to claim 1, wherein an auxiliary capacitor that accumulates generated electric charges is provided electrically in parallel with each of the sensor sections, at least at one end of each of the sensor sections.
